(19) United States
(12) Patent Application Publication
(10) Pub. No.: US 2004/0079119 A1
(43) Pub. Date: Apr. 29, 2004

(54) Apparatus for producing optical fiber preform

(75) Inventors: Kazuhisa Fukutani, Kobe-shi (JP); Masahiko Mitsuda, Kobe-shi (JP); Takehiko Yamamoto, Kawasaki-shi (JP); Jiro Morinaga, Kawasaki-shi (JP)

Correspondence Address: REED SMITH LLP, Suite 1400, 3110 Fairview Park Drive, Falls Church, VA, 22042, US

(73) Assignee: Kabushiki Kaisha Kobe Seiko Sho.

(21) Appl. No.: 10/682,929

(22) Filed: Oct. 14, 2003

(30) Foreign Application Priority Data
Oct. 23, 2002 (JP) 2002-308448

(51) Int. Cl. C03B 37/018

(52) U.S. Cl. 65/531

(57) ABSTRACT

A reaction chamber including a reaction chamber in which preform is formed is provided. A cladding burner for forming a cladding of the preform is arranged in the reaction chamber, and a blocking member for suppressing ascending of the air in the reaction chamber is provided above the cladding burner. With this arrangement, abrupt flame-up of a flame containing glass particles produced through the burner is suppressed, the productivity of a preform is improved by accelerated formation of a preform, and the amount of glass particles which may adhere to a wall of the reaction chamber is reduced.

### FIELD OF THE INVENTION

The present invention relates to an apparatus for producing optical fiber preform by depositing glass particles called soot formed by a burner.

### BACKGROUND OF THE INVENTION

An optical fiber preform is usually produced by Vapor Phase Axial Deposition (VAD) process. According to the VAD process, in a reaction chamber, starting chemicals are supplied into oxygen-hydrogen flame generated by a burner to produce glass particles which are then deposited on an end of a seed rod. Air is flowed in a horizontal direction from one side of the reaction chamber toward the other side. The burner is provided on the air inflow side. The seed rod deposited with glass particles is lifted while being rotated, consequently producing an optical fiber preform having a double-cylinder structure consisting of a core and a cladding. In the VAD process, it is significant to direct the flame containing glass particles onto the seed rod in a stable manner in order to produce a preform of high quality having desired deposition of glass particles because the deposit quantity of glass particles per unit time affects the diameter of the preform formed on the seed rod.

Japanese Unexamined Patent Publication No. HEI 11-343135 discloses an arrangement in which an air filter is provided in an air inflow passage of the reaction chamber to define an air chamber for accommodating air temporarily, and the air blown into the air accommodating chamber is temporarily trapped therein so that the air is flowed into the reaction chamber in a stable manner via the air filter. In this arrangement, the air which has been blown into the air accommodating chamber in a turbulent state is made to be laminar state by the combination of the air accommodating chamber and the air filter before being flowed into the reaction chamber in an attempt to stabilize the direction of the flame.

Further, Japanese Unexamined Patent Publication No. 2000-290035 discloses an arrangement in which an air blocking plate is disposed on one side of a reaction chamber in such a manner as to extend in a direction orthogonal to the direction of air streams so that the air blocking plate keeps the air from flowing into the region around the burner flame to stabilize the burner flame. Further, Japanese Unexamined Utility Model Publication No. HEI 1-108504 discloses an arrangement in which an air blocking plate is disposed above a burner and on an air inflow side to block the air from being blown into the region around the burner flame so as to stabilize the-burner flame.

However, the arrangement in the Publication No. HEI 11-343135 has suffered from difficulty in sufficiently stabilizing the burner flame because of a long distance from the air filter to the tip of the burner flame. The reason for causing such a difficulty is conceived as follows.

Generally, when the flame is generated by the burner, the horizontally regulated air stream in the reaction chamber is subjected to thermal expansion by heat of the flame in passing near the flame, and as a result, is likely to ascend. Therefore, in the case where the distance from the air filter to the tip of the burner flame is long, as disclosed in the Publication No. HEI 11-343135, the heated air is likely to ascend freely without a hindrance. As the time lapses, the ratio of the ascending air stream to the horizontal air stream becomes relatively large, resulting in a remarkable loss in the air flow uniformity. As the air flow regulation uniformity is lost, the burner flame is apt to flame up accompanied by the ascending air stream. Thus, the burner flame is uncontrollable and brought to an unstable state.

Due to the aforementioned reason, in the apparatus disclosed in the Publication No. HEI 11-343135, the density of glass particles contained in the flame may be lowered or varied, thereby varying the diameter of the preform formed on the seed rod by deposition of glass particles. Furthermore, this arrangement suffers from a drawback that a large quantity of glass particles may adhere to the upper wall of the reaction chamber, with the result that glass particles adhered to the upper wall may come off and adhere to the preform as impurities.

In the arrangements disclosed in the Publication Nos. 2000-290035 and HEI 1-108504, the air is not directed to the burner. As a result, it is highly likely that the outer wall of the burner is overheated, and particularly, in the case of forming a preform with large flame, the useful life of the burner may be shortened.

### SUMMARY OF THE INVENTION

It is an object of the present invention to provide an apparatus for producing an optical fiber preform which is free from the problems residing in the prior art.

According to an aspect of the present invention, an optical fiber preform producing apparatus is adapted for producing an optical fiber preform having a core and a cladding. The apparatus comprises a reaction chamber in which a preform is formed. The reaction chamber is so constructed as to direct a gas from one side of the reaction chamber to the other side of the reaction chamber in a horizontal direction. The apparatus is further provided with a core burner for producing a flame containing glass particles from one side of the reaction chamber to form a core; a cladding burner for producing a flame containing glass particles from the same side of the reaction chamber to form a cladding around the core; a lifting mechanism for lifting the preform being formed while rotating the preform about an axis thereof; and a baffle arranged above the cladding burner in the reaction chamber for directing the flow of the gas in the reaction chamber.

The optical fiber preform producing apparatus secures a long useful life of the burners and stabilizes the burner flame, and prevents adhesion of glass particles onto an upper wall of the reaction chamber.

These and other objects, features and advantages of the present invention will become more apparent upon reading of the following detailed description along with the accompanying drawings.

### BRIEF DESCRIPTION OF THE DRAWINGS

FIG. 1 is a schematic diagram of an apparatus for producing an optical fiber preform according to an embodiment of the present invention.

FIG. 2 is a cross-sectional view taken along the line II-II in FIG. 1.

FIG. 3 is a schematic diagram of an apparatus for producing an optical fiber preform according to another embodiment of the present invention.

FIG. 4 is a cross-sectional view taken along the line IV-IV in FIG. 1, showing an air flow in first and second air receptacle sections.

FIG. 5 is a cross-sectional view taken along the line IV-IV in FIG. 1, showing another air flow in the first and second air receptacle sections.

### DETAILED DESCRIPTION OF THE PREFERRED EMBODIMENTS OF THE INVENTION

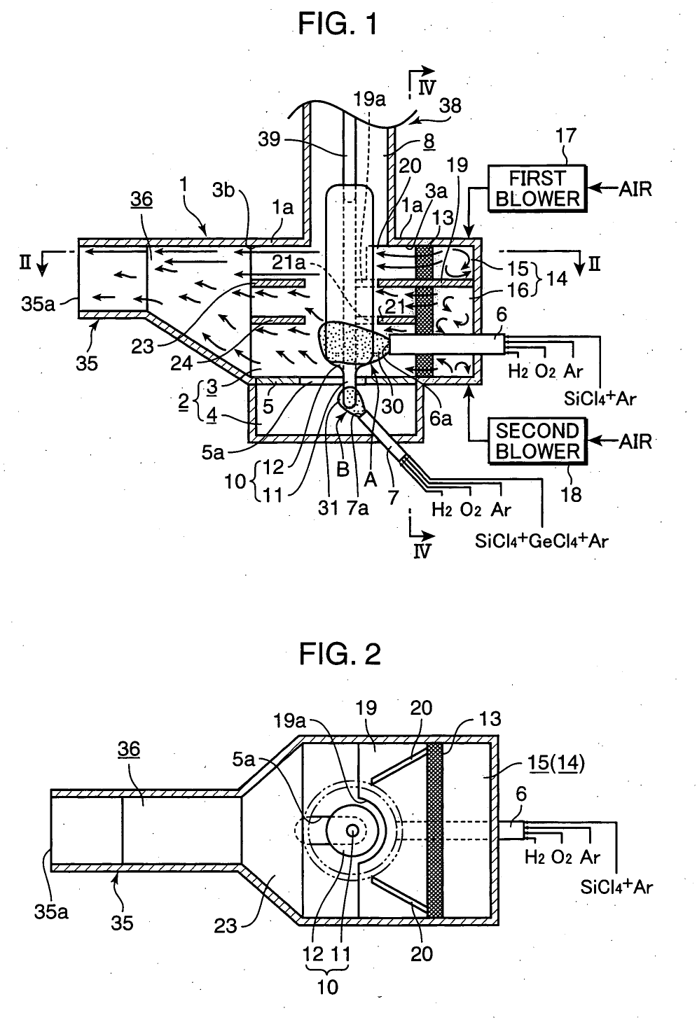

An apparatus for producing an optical fiber preform according to an embodiment of the present invention will be described with reference to FIGS. 1 and 2. The apparatus has, as shown in FIG. 1, a reactor vessel 1. The reactor vessel 1 is made of an acid-proof and heat-proof material. First baffle 19, second baffle 21, third baffle 23, and fourth baffle 24 are each made of a material equivalent to the material composing the reactor vessel 1.

The reactor vessel 1 is internally provided with a reaction chamber 2, an air chamber 14, an outflow section 35, and a preform accommodating chamber 8. The air chamber 14 is defined on one side of the reaction chamber 2, the outflow section 35 is defined on the other side of the reaction chamber 2 opposite to the air chamber 14, and the preform accommodating chamber 8 is defined in an upper part of the reaction chamber 2. As will be described later, a preform 10 is formed in the reaction chamber 2. The preform 10 has a double-cylinder structure in which a cladding 12 surrounds a core 11 annularly. The core 11 and the cladding 12 are each formed by deposition of glass particles.

A horizontally extending partition wall 5 is provided in the reaction chamber 2 at an appropriate position in a lower part of the reaction chamber 2 to divide the reaction chamber 2 into an upper section or cladding forming section 3 and a lower section or core forming section 4 by the partition wall 5. A through hole 5a is formed in the partition wall 5.

The cladding forming section 3 has a substantially rectangular parallelepiped, and is formed with an air inflow port 3a at one side (right side in FIG. 1) thereof, and an air outflow port 3b at the opposite side (left side in FIG. 1) to the air inflow port 3a. A filter 13 is provided in the air inflow port 3a. The filter 13 and an inner wall of the reactor vessel 1 define the air chamber 14.

The first baffle 19 divides the air chamber 14 into an upper section (first air reservoir section 15) which is defined on the side of an upper wall 1a of the reactor vessel 1, and a lower section (second air reservoir section 16) which is defined below the first air reservoir section 15. A first blower 17 is connected with the first air reservoir section 15, and a second blower 18 is connected with the second air reservoir section 16. The first and second blowers 17, 18 supply the air outside of the reactor vessel 1 into the first and second air reservoir sections 15, 16 at respective given supplying rates. The thus supplied air is introduced into the cladding forming section 3 through the filter 13 after temporarily being trapped in the first and second air reservoir sections 15, 16.

In this embodiment, the air supplying rates through the first and second blowers 17, 18 are regulated based on, for instance, the volumes of the first and second air reservoir sections 15, 16 in such a manner that the air stream near the upper wall 1a of the cladding forming section 3 is caused to flow at a higher speed than the air streams flowing through the other zones.

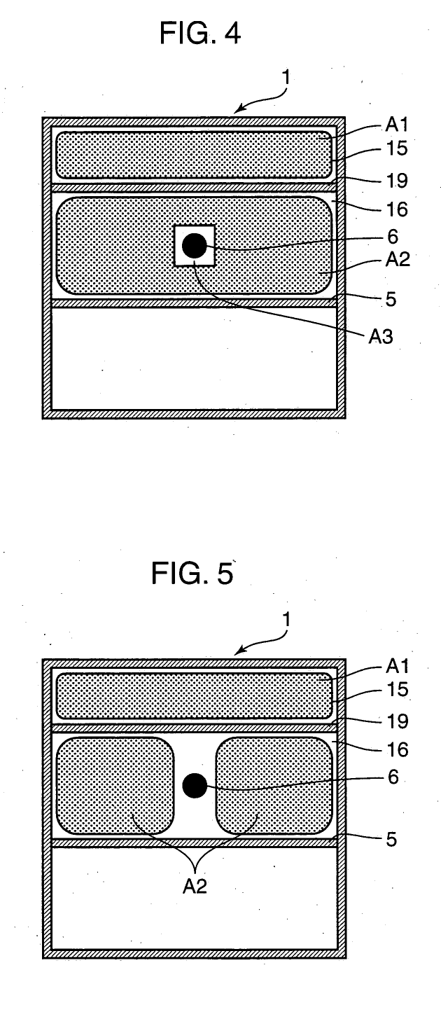

The manner as to how the air is supplied from the first and second air reservoir sections 15, 16 (i.e. air chamber 14) into the reaction chamber 2 is optionally selected. FIGS. 4 and 5 illustrate examples of air flow zones A1, A2 through which the air is supplied from the first and second air reservoir sections 15, 16 into the reaction chamber 2.

In the example shown in FIG. 4, a burner installation zone A3 which a cladding burner 6 occupies is considerably small, and the air is flowed into the upper section 3 of the reaction chamber 2 from the first air reservoir section 15 and the second air reservoir section 16 except for the burner installation zone A3.

In the example shown in FIG. 5, two air flow zones A2 are provided while a burner installation zone A3 is provided between the two air flow zones A2. Namely, the air is supplied through the two air flow zones A2 from the second air reservoir section 16.

The first baffle 19 extends horizontally from the air chamber 14 through the filter 13 to such a region where the preform 10 is formed. The first baffle 19 suppresses ascending of the air in the cladding forming section 3. It is preferable to provide the first baffle 19 in such a manner as to divide the air flowing through the cladding forming section 3 into two air streams, that is, an upper air stream which has a high flowing speed, a lower air stream which has a low flowing speed, as described later, respectively defined below and above the first baffle 19. With this arrangement, horizontal air flow into the cladding forming section 3 is carried out smoothly by flowing the air into the upper section and the lower section below and above the first baffle 19.

As shown in FIG. 2, a cutaway 19a having such a contour as to partially enclose a body of the preform 10 (in the drawing, arc-shape in plan view) is formed in a leading end of the first baffle 19. The cutaway 19a serves to reduce the clearance between the body of the preform 10 and the leading end of the first baffle 19, thereby suppressing ascending of the air through the clearance.

A pair of air deflectors 20 are arranged above the first baffle 19 symmetrically with respect to an axial direction of the seed rod 39. The air deflectors 20 are disposed between the first baffle 19 and the upper wall 1a of the cladding forming section 3. As shown in FIG. 2, the air deflector 20 (20) has a tail end thereof (end near the filter 13) connected to an outer end of the filter 13 in a widthwise direction, and a frontal end thereof (end near the preform 10) inwardly inclined relative to the tail end with respect to the widthwise direction. With this arrangement, the air deflectors 20 guide the air stream supplied from the first air reservoir section 15 into the cladding forming section 3 to be oriented from the widthwise outer end radially inwardly toward the preform forming site. Thus, even if the air supplying volume from the first air reservoir section 15 is small, sufficient air flowing speed and air supply amount toward the preform 10 are secured by guiding the air streams radially inwardly toward the preform forming site, while maintaining their horizontal levels.

Referring back to FIG. 1, a second baffle 21 is disposed a certain distance below the first baffle 19 in the cladding forming section 3. The second baffle 21 extends horizontally from the filter 13 toward the preform forming site.

For the same reason as providing the first baffle 19, the second baffle 21 is provided to suppress ascending of the air in the cladding forming section 3, which also may give rise to abrupt flame-up and fluctuation of the flame 30 from the cladding burner 6, at least on an upstream side in the air flowing direction relative to the preform forming site. As the first baffle 19, a cutaway 21a having such a contour as to partially enclose the body of the preform 10 is formed in a leading end of the second baffle 21. The cutaway 21a serves to reduce the clearance between the body of the preform 10 and the leading end of the second baffle 21, thereby suppressing ascending of the air stream through the clearance.

In this way, arranging a multi-step baffle (in this embodiment, the first baffle 19 and the second baffle 21) in the cladding forming section 3 further effectively suppresses ascending of the air stream.

Referring back to FIG. 1, the cladding burner 6 is arranged at an appropriate position below the second baffle 21 in the cladding forming section 3 so as to direct the flame 30 toward the cladding forming site A. Specifically, the cladding burner 6 has an opening 6a directed to the body of the preform 10 within the cladding forming site A. The cladding forming site A corresponds to an area having an optimum height and width for efficiently forming the cladding 12 by depositing glass particles in the flame 30 onto the seed rod 39.

The cladding burner 6 is disposed in such a direction as to substantially coincide the direction of producing the flame 30 with the air flowing direction (namely, horizontal direction). Specifically, the cladding burner 6 extends horizontally through the second air reservoir section 16 and the filter 13 with a tail end thereof exposed outside of the apparatus.

The cladding burner 6 may be tilted with the opening 6a being disposed at an upper level relative to the tail end of the cladding burner 6.

The cladding burner 6 has a multi-tubular structure, wherein each tubular member is made of silica, and plural annular gas channels are formed one over another from a radially central part toward a radially outer part. The tail end of the cladding burner 6 is connected with a gas supplying device. The gas supplying device supplies hydrogen (H₂) gas, oxygen (O₂) gas, argon (Ar) gas and quarternary silicon chloride (SiCl₄+Ar) gas at their respective supplying rates into the corresponding gas channels of the cladding burner 6.

The partition wall 5 is provided below the cladding burner 6. As mentioned above, the partition wall 5 divides the reaction chamber 2 into the cladding forming section 3 and the core forming section 4, and serves as a blocking member for smoothly directing the air stream below the cladding burner 6 horizontally toward downstream. In other words, the partition wall 5, the first baffle 19, and the second baffle 21 altogether secure horizontal air streams in the cladding forming section 3.

The third baffle 23 and the fourth baffle 24 are arranged at the opposite side (downstream side) in the air flow direction to the first baffle 19 and the second baffle 21 in the cladding forming section 3.

The third baffle 23 and the fourth baffle 24 horizontally extend and, are arranged substantially at the same height as the first baffle 19 and the second baffle 21 arranged on the upstream side. The third baffle 23 and the fourth baffle 24 regulate the air streams on the downstream side relative to the preform forming site so that the air flows horizontally. Arranging a multi-step baffle (in this embodiment, the third baffle 23 and the fourth baffle 24) in the cladding forming section 3 further effectively secures horizontal air streams in the cladding forming section 3.

Similarly to the cladding burner 6, a core burner 7 having a multi-tubular structure is arranged in the core forming section 4. In other words, the partition wall 5 serves as a separating member by which the cladding burner 6 is disposed in the cladding forming section 3 and the core burner 7 is disposed in the core forming section 4 separately from each other.

The core burner 7 is so arranged as to direct the flame 31 from one side of the core forming section 4 toward the core forming site B. Specifically, the core burner 7 has an opening 7a directed to the core 11 within the core forming site B. The core forming site B corresponds to an area having an optimum height and width for efficiently forming the core 11 by depositing glass particles in the flame 31 on the seed rod 39, which will be described later. The core burner 7 is tilted in such a way as to dispose a tail end thereof at a lower level relative to the burner opening 7a with the tail end being exposed outside of the apparatus.

In the similar manner as the cladding burner 6, the core burner 7 has a multi-tubular structure, wherein plural annular gas channels are formed one over another from a radially central part toward a radially outer part, and a tail end of the core burner 7 is connected with a gas supplying device. The gas supplying device supplies hydrogen (H₂) gas, oxygen (O₂) gas, argon (Ar) gas and quarternary silicon chloride (SiCl₄+GeCl₄+Ar) gas at their respective supplying rates into the corresponding gas channels of the core burner 7.

The outflow section 35 has an outflow passage through which the air in the cladding forming section 3 is drawn outside of the apparatus. The outflow section 35 has openings at opposite ends in a longitudinal direction (air flowing direction) thereof. The one opening of the outflow section 35 is communicated with the air outflow port 3b of the cladding forming section 3, and the other opening thereof serves as an outflow opening 35a.

The upper wall 1a of the reactor vessel 1 constituting the outflow section 35 extends horizontally in the similar manner as the upper wall 1a of the reactor vessel 1 constituting the cladding forming section 3. With this arrangement, resistance against the high-speed air stream is reduced, and an ascending air stream in the reactor vessel 1 is easily discharged. On the other hand, the lower wall of the reactor vessel 1 constituting the outflow section 35 is tilted upward with respect to the air flowing direction toward the outflow port 3a. Specifically, an outflow passage 36 in the outflow section 35 has such a configuration as to gradually decrease the cross section thereof for air outflow from the air outflow port 3b toward the outflow opening 35a. Reducing the cross section for air outflow from the air outflow port 3b toward the outflow opening 35a enhances air outflow force, contributes to efficient outflow of air and glass particles from the cladding forming section 3, and suppresses air stagnation in the cladding forming section 3.

A lifting mechanism 38 is provided above the cladding forming section 3. The lifting mechanism 38 includes a lifting device for lifting the preform 10 upward, and the preform accommodating chamber 8 for accommodating the preform 10 formed with the core and the cladding. The lifting device is so constructed as to draw the preform 10 upward while rotating the same in such a manner that the tip and the body of the preform 10 are respectively located in the core forming site B and the cladding forming site A. Specifically, the apparatus is so designed that the preform 10 is formed in such a condition that the core 11 is formed in the core forming site B at a constant rate and the cladding 12 is formed around the core 11 with a desired thickness in the cladding forming site A.

In the following, described is an operation as to how the preform 10 is formed by the VAD process with use of the inventive apparatus having the above construction.

First, the seed rod 39 is suspended from the lifting device, and is disposed at such a position as to locate a tip of the seed rod 39 in the core forming site B in the core forming section 4. Then, the first blower 17 and the second blower 18 are driven, and the air outside of the apparatus is supplied to the first air reservoir section 15 and the second air reservoir section 16. At this time, the air pressure in the first air reservoir section 15 is set higher than the air pressure in the second air reservoir section 16.

The air supplied to the first air reservoir section 15 is allowed to flow into the high-speed air stream zone in the cladding forming section 3 at a relatively high speed via the filter 13 after temporarily being trapped in the first air reservoir section 15. The high-speed air stream zone is defined by the first baffle 19 and the upper wall 1a of the reactor vessel 1. Once the air enters the high-speed air stream zone, the air stream flows smoothly toward the preform forming site while being horizontally guided along the first baffle 19. At the same time, the air stream has its flowing direction oriented and supplying rate accelerated toward the preform forming site by the air deflectors 20. The air stream entered the high-speed air stream zone is guided toward the preform 10 as a high-speed air stream. After passing the preform 10, the high-speed air stream is discharged out of the apparatus through the outflow opening 35a while being horizontally guided along the upper wall 1a of the reactor vessel 1.

On the other hand, the air supplied to the second air reservoir section 16 is allowed to flow into the low-speed air stream zone in the cladding forming section 3 via the filter 13 after temporarily being trapped in the second air reservoir section 16. The low-speed air stream zone is defined by the first baffle 19 and the partition wall 5. Once the air enters the low-speed air stream zone, the air stream flows smoothly toward downstream while being horizontally guided along the lower surface of the first baffle 19 and the upper surface of the second baffle 21, and along the lower surface of the second baffle 21 and the upper surface of the partition wall 5. Part of the air stream is supplied to the cladding burner 6 to cool the cladding burner 6, and then enters the cladding forming site A. Thereafter, the air stream is discharged out of the apparatus through the outflow opening 35a while having its flowing direction regulated horizontally by the third baffle 23 and the fourth baffle 24 arranged at the downstream side relative to the preform forming site. Air stream may be partially fluctuated by obstruction by the cladding burner 6. However, such fluctuation can be minimized by the first baffle 19 and the second baffle 21.

The air streams in the cladding forming section 3 are discharged out of the apparatus with a large outflow force because of the gradually reduced-cross section of the outflow passage 36 toward the outflow opening 35a. With this arrangement, it is less likely that the air may be stagnated in the high-speed air stream zone and the low-speed air stream zone.

When the air is flowed into the cladding forming section 3, hydrogen (H₂) gas, oxygen (O₂) gas, argon (Ar) gas, and quarternary silicon chloride (SiCl₄+GeCl₄+Ar) gas are supplied to the core burner 7 from the gas supplying device. Upon supply of these gases, the core burner 7 is ignited, and the flame 31 containing glass particles is directed from the core burner 7 toward the core forming site B. As a result of the supply of the flame 31, the glass particles are adhered and deposited on the tip of the seed rod 39 located in the core forming site B. As the seed rod 39 is lifted upward by the lifting device while being rotated, the core 11 of a certain diameter is formed. The core 11 is formed in an axial direction of the seed rod 39 with an outermost layer of the core 11 being located in the core forming site B.

In the above embodiment of forming the core 11, the opening 7a of the core burner 7 is housed in the core forming section 4 in a state that the air flow in the core forming section 4 is blocked. This arrangement prevents the likelihood that the flame 31 from the core burner 7 is exceedingly fluctuated due to air stream, and accordingly, the core 11 is uniformly formed. Since the calorific value of the flame 31 through the core burner 7 is set at a relatively small value, there is no likelihood that the core burner 7 may be melted due to overheat by the flame 31 even if the air is not supplied to the core burner 7 to cool the core burner 7.

Upon lapse of a certain time after the core 11 is formed in the core forming site B, hydrogen (H₂) gas, oxygen (O₂) gas, argon (Ar) gas, and quarternary silicon chloride (SiCl₄+Ar) gas are supplied from the gas supplying device into the corresponding gas channels of the cladding burner 6. Upon supply of the gases, the cladding burner 6 is ignited, and the flame 31 containing glass particles in the flame 31 is supplied toward the cladding forming site A. As a result of the supply of the flame 31, the glass particles are adhered and deposited around the core 11, and the cladding 12 of a certain diameter is formed around the core 11. In this way, glass particles in the flames 30, 31 from the cladding burner 6 and the core burner 7 are deposited onto the seed rod 39 so as to form the core 11 and the cladding 12, respectively. As the seed rod 39 with the core 11 and the cladding 12 being deposited one over the other is lifted upward while being rotated, the preform 10 in a double-cylinder structure consisting of the core 11 and the cladding 12 is formed, and accommodated in the preform accommodating chamber 8.

While the flame 30 is produced from the cladding burner 6 toward the cladding forming site A, the horizontal air stream in the clad forming section 3 is subjected to thermal expansion due to heat of the flame 30 in passing the cladding forming site A, and accordingly, is likely to ascend. However, since the multi-step baffle comprised of the first baffle 19 and the second baffle 21 is disposed on the upstream side relative to the preform forming site, and the multi-step baffle comprised of the third baffle 23 and the fourth baffle 24 is disposed on the downstream side relative to the preform forming site, ascending of the air stream is suppressed by the first to fourth baffles 19, 21, 23, 24.

Furthermore, the first baffle 19 and the second baffle 21 are respectively formed with the cutaways 19a and 21a having such a contour as to partially enclose the body of the preform 10. With this arrangement, since the clearance between the first baffle 19 (or the second baffle 21) and the preform 10 is reduced, ascending of the air on the upstream side through the clearance is furthermore effectively suppressed.

As mentioned above, undesirable air fluctuation is prevented because ascending of the air is suppressed by the first to fourth baffles 19, 21, 23, 24, and the cutaways 19a, 21a. As a result, abrupt flame-up and fluctuation of the flame 30 through the cladding burner 6 due to ascending of the air stream are suppressed, and the cladding 12 of densely and uniformly distributed glass particles is formed. Further, as the abrupt flame-up of the flame 30 is suppressed, a great deal of the flame 30 reaches the preform forming site. Accordingly, the entirety of the body of the preform 10 is surrounded by the flame 30, and formation of the cladding 12 is accelerated.

Generally, glass particles that have not been used to form the preform 10 may ascend along with the ascending air stream. However, since ascending of the air stream is suppressed as mentioned above in this embodiment, the amount of the glass particles that may reach the upper wall 1a of the cladding forming section 3 is reduced, as compared with the conventional arrangement where the air ascending suppressing measure is not taken. Also, the downstream-side third and fourth baffles 23, 24 serve to prevent ascending of glass particles on the downstream side. Furthermore, even if glass particles reach near the upper wall 1a, the high-speed air stream in the zone near the upper wall 1a expels most of the glass particles near the upper wall 1a. Accordingly, the amount of glass particles adhering to the upper wall 1a is significantly small, and even if glass particles are adhered to the upper wall 1a, such glass particles are difficult to come off. In the case that glass particles adhering to the upper wall 1a should come off, such glass particles are discharged out of the apparatus along with the high-speed air stream. Thus, this arrangement eliminates or suppresses the likelihood that glass particles may adhere to the preform 10 as impurities.

Despite the above arrangement, the case should be considered that glass particles may adhere to the downstream-side third and fourth baffles 23, 24, and come off therefrom. However, the third and fourth baffles 23, 24 are sufficiently away from the preform forming site, and glass particles that are not used to form the preform 10 are conveyed downstream relative to the preform forming site by the high-speed air stream. This arrangement prevents glass particles that are not used to form the preform 10 from adhering to the preform 10.

In this way, the preform 10 of a desired length is formed by the VAD process with use of the inventive apparatus. After the VAD process, the preform 10 is taken out of the apparatus, and transferred to a sintering process. In the sintering process, the preform 10 is formed into a transparent preform by sintering and vitrifying the glass particles of the preform 10. In case that the diameter of the preform is exceedingly small, a transparent preform of a desired diameter can be produced by cyclically repeating formation of a new cladding 12 in the VAD process and vitrification in the sintering process. According to this embodiment, even if the VAD process is cyclically repeated, the preform 10 of a high quality can be produced with use of the inventive apparatus. After the VAD process and the sintering process are carried out, the preform is drawn in a drawing process, whereby a transparent preform having a desired length and diameter is produced. Thereafter, the drawn preform is formed into optical fiber by a fiber drawing process.

As mentioned above, this embodiment is directed to the apparatus for forming optical fiber preform in a double-cylinder structure consisting of the core 11 and the cladding 12 by depositing glass particles. The apparatus comprises the reaction chamber 2 in which the preform 10 is formed, as well as the reactor vessel 1 so constructed as to allow the air to flow horizontally from one side to the other side in the reaction chamber 2, the core burner 7 for forming the core 11 by producing the flame 31 containing glass particles from upstream in the air flowing direction toward the core forming site B, the cladding burner 6 for forming the cladding 12 around the core 11 by producing the flame 31 containing glass particles from upstream in the air flowing direction toward the cladding forming site A, the lifting mechanism 38 for drawing the preform 10 upward while rotating the same in such a manner that the tip and body of the preform 10 are respectively located in the core forming site B and the cladding forming site A, and the first, second, third, fourth baffles 19, 21, 23, 24 each disposed horizontally in the reaction chamber 2 so as to secure horizontal air streams in the reaction chamber 2. The air to be drawn into the reaction chamber 2 in this embodiment is preferably the one which has passed through a filter or a grating before being supplied into the reaction chamber 2. The filter is preferably a High Efficiency Particulate Air (HEPA) filter.

In the above arrangement, ascending of the air is suppressed, and excessive air fluctuation is prevented by securing air streams in the reaction chamber 2 horizontally by the first, second, third, fourth baffles 19, 21, 23, 24. Since abrupt flame-up and fluctuation of the flame 30 through the cladding burner 6 can be suppressed in this arrangement, the cladding 12 of densely and uniformly distributed glass particles is formed. Further, since abrupt flame-up of the flame 30 is suppressed, a great deal of flame 30 reaches the preform forming site. As a result, it is easy for the flame 30 to surround the entirety of the body of the preform 10, thereby accelerating formation of the cladding 12.

Further, since the ascending of the air is suppressed, the amount of glass particles adhering to the upper wall 1a can be reduced. As a result, it is less likely that glass particles coming off from the upper wall 1a may adhere to the preform 10 as impurities. Thereby, the preform 10 of a desired diameter can be produced in a stable manner and in a high yield. Further, the cladding burner 6 high in calorific value can be cooled by supplying the air onto the cladding burner 6, which contributes to extension of useful life of the cladding burner 6.

In this embodiment, the air is supplied into the reaction chamber 2. This invention is not limited thereto. An inert gas may be supplied, for example.

In this embodiment, two burners, i.e., the cladding burner 6 and the core burner 7, are used to form the preform 10. Alternatively, more than two burners may be used to form the preform 10.

In this embodiment, all the baffles (first, second, third, fourth baffles 19, 21, 23, 24) are used to suppress ascending of the air. Alternatively, at least one of the baffles 19, 21, 23, 24 may be provided to suppress ascending of the air.

Specifically, either one of the first baffle 19 and the second baffle 21 which are disposed on one side of the reaction chamber 2 and above the cladding burner 6 may be provided. In such an altered arrangement, since the first baffle 19 or the second baffle 21 is disposed on the one side of the reaction chamber 2 and above the cladding burner 6, the horizontal air supplying on the upstream side relative to the preform forming site is secured. As a result, ascending of the air, which may give rise to abrupt flame-up and fluctuation of the flames 30, 31, is suppressed on the upstream side in the air flowing direction relative to the preform forming site. Preferably, however, the two-step arrangement as shown in this embodiment is effective in suppressing ascending of the air.

Alternatively, either one of the third baffle 23 and the fourth baffle 24 may be disposed on the other side of the reaction chamber 2 and above the cladding burner 6. In such an altered arrangement, since the third baffle 23 or the fourth baffle 24 is disposed on the other side of the reaction chamber 2 and above the cladding burner 6, the horizontal air supplying on the downstream side relative to the preform forming site is secured. As a result, since ascending of the air, which may give rise to abrupt flame-up and fluctuation of the flames 30, 31, is suppressed on the downstream side in the air flowing direction relative to the preform forming site, the preform 10 of a desired diameter can be produced in a stable manner and in a high yield. Preferably, however, the two-step arrangement as shown in this embodiment is effective in suppressing ascending of the air.

The present invention is not limited to the above arrangement, as illustrated in FIG. 1, in which the first baffle 19 and the second baffle 21 are disposed On the upstream side, and the third baffle 23 and the fourth baffle 24 are disposed on the downstream side.

As illustrated in FIG. 1, the cutaway 19a in the first baffle 19 and the cutaway 21a in the second baffle 21 have such a contour as to partially enclose the body of the preform 10 in this embodiment. The present invention is not limited thereto. Alternatively, the first baffle 19, the second baffle 21, the third baffle 23, and the fourth baffle 24 each may be formed with a cutaway. Further alternatively, at least one of the first to fourth baffles 19, 21, 23, 24 may be formed with a cutaway.

It is preferable to arrange the first to fourth baffles 19, 21, 23, 24 at respective predetermined positions in such a manner that the air flowed into the reaction chamber 2 is guided at different locations from each other in a vertical direction. With such an arrangement, since the air is allowed to pass through the reaction chamber 2 separately in individual sections below and above the first to fourth baffles 19, 21, 23, 24, the horizontal air streams in the reaction chamber 2 can be secured.

The inventive apparatus in this embodiment is provided with a gas supplying mechanism including the first air reservoir section 15 and the first blower 17, in which the gas supplying mechanism is so constructed as to set the velocity of the air stream near the upper wall 1a of the reaction chamber 2 higher than those of the other air streams in the reaction chamber 2. With this arrangement, even if part of the glass particles contained in the flames 30, 31 from the core burner 7 and the cladding burner 6 fails to form the preform 10 and ascends, such glass particles are blown off downstream and discharged out of the apparatus along with the high-speed air stream before adhering to the upper wall 1a of the cladding forming section 3.

Further, the inventive apparatus according to this embodiment has the arrangement in which the cross section of the outflow section 35 disposed on the other side or downstream side of the reaction chamber 2 has a reduced size toward the outflow opening 35a. With this arrangement, the air outflow force of the outflow section 35 is increased, and efficient air outflow is feasible. Alternatively, the outflow section 35 may be provided with an air outflow pump to forcibly outflow the air out of the reaction chamber 2.

Furthermore, in the apparatus according to this embodiment, the reaction chamber 2 is divided into the cladding forming section 3 for housing the cladding burner 6 and the core forming section 4 for housing the core burner 7 by the partition wall 5. With this arrangement, even if a reflux air stream directed toward the core burner 7 is generated inside the outflow section 35, such reflux air stream is blocked from reaching the core forming section 3 by the partition wall 5. Thus, this arrangement suppresses fluctuation of the flame 31 through the core burner 7 due to such reflux air stream.

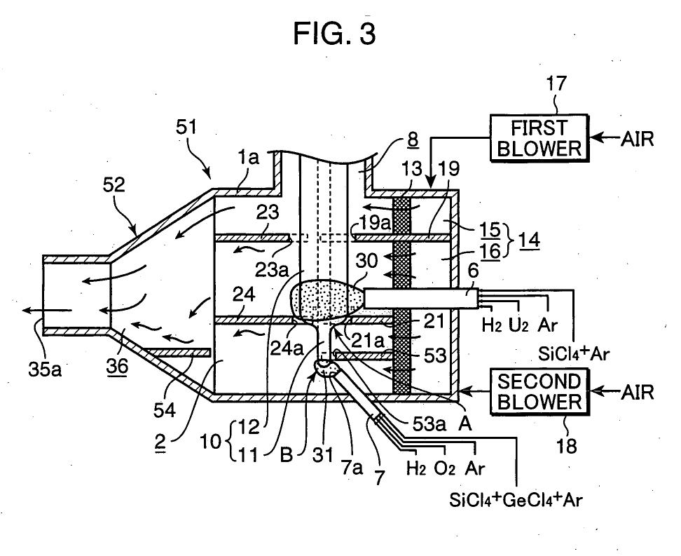

Next, an apparatus for producing optical fiber preform according to another embodiment of the invention is described referring to FIG. 3. Elements in the second embodiment identical to those in the first embodiment are denoted at the same reference numerals, and description thereof is omitted herein.

The apparatus according to this embodiment is provided with a reactor vessel 51. The reactor vessel 51 is internally provided with a reaction chamber 2 in which a preform 10 is formed, an air chamber 14, an outflow section 52, and a preform accommodating section 8. The air chamber 14 is defined on one side of the reaction chamber 2, the outflow section 52 is defined on the other side of the reaction chamber 2 opposite to the air chamber 14, and the preform accommodating chamber 8 is defined in an upper part of the reaction chamber 2. The air chamber 14 is defined by a filter 13 and the side wall of the reactor vessel 51. The filter 13 is vertically arranged in the reactor vessel 51 in such a way as to entirely come into contact with the inner surface of the reactor vessel 51. The outflow section 52 includes an outflow opening 35a formed in the middle of the other side wall of the reaction chamber 2. The outflow section 52 has such a configuration that a cross section of an outflow passage 36 orthogonal to an air flowing direction is reduced toward the outflow opening 35a. An upper wall 1a of the reactor vessel 51 has a horizontal part extending from the air chamber 14 to the reaction chamber 2, and a downward ramp toward the outflow opening 35a.

A cladding burner 6 and a core burner 7 are arranged in the reaction chamber 2. A first baffle 19 is provided above the cladding burner 6, and a second baffle 21 is provided below the cladding burner 6. The second baffle 21 is arranged at a height sufficiently near a cladding forming site A.

A fifth baffle 53 is provided between the second baffle 21 and the core burner 7. The fifth baffle 53 is arranged at a height sufficiently near a core forming site B.

The baffles 19, 21, 53 each is arranged to extend horizontally, and are formed with arc-shape cutaway 19a, 21a, 53a, respectively. The contour of the cutaway 19a (21a, 53a) conforms to the diameter of the preform 10 to minimize air leakage through the clearance between the baffle 19 (21, 53) and the preform 10.

A third baffle 23 and a fourth baffle 24 are provided on the other side of the reaction chamber 2 opposite to the first baffle 19 and the second baffle 21. The third baffle 23 is arranged substantially at the same height as the first baffle 19, and the fourth baffle 24 is arranged substantially at the same height as the second baffle 21. The third baffle 23 and the fourth baffle 24 are formed with arc-shape cutaways 23a, 24a, respectively. The third baffle 23 and the fourth baffle 24 are arranged at such a position that the cutaways 23a and 24a partially enclose the body of the preform 10. Similarly to the cutaways 19a, 21a, 53a, the contour of the cutaway 23a (24a) conforms to the diameter of the preform 10 to minimize air leakage through the clearance between the baffle 23 (24) and the preform 10.

A blocking plate 54 is provided at an appropriate position in the outflow passage 36 of the outflow section 52. The blocking plate 54 extends horizontally from an intermediate position on a lower wall of the outflow passage 36 toward the reaction chamber 2 to block a reflux air stream from being directed from a bottom wall of the reactor vessel 51 toward the core burner 7. The other arrangement of the second embodiment is identical to that of the first embodiment.

Now, an operation of the apparatus having the above construction is described. First, a seed rod is suspended from a lifting device in such a manner that a tip of the seed rod is located in the core forming site B. Then, a first blower 17 and a second blower 18 are driven to supply the air outside of the apparatus into a first air reservoir section 15 and a second air reservoir section 16 of the air chamber 14, respectively. Relatively high-speed air streams are supplied from the first air reservoir section 15 to the reaction chamber 2, while relatively low-speed air streams are supplied from the second air reservoir section 15 to the reaction chamber 2. With this arrangement, since high-speed air streams flow near the upper wall 1a, the upper wall 1a is prevented from adhesion of glass particles.

The air supplied from the second air reservoir section 16 to the reaction chamber 2 is smoothly guided horizontally along the first baffle 19, second baffle 21, and the fifth baffle 53 toward downstream in the air flowing direction in the reaction chamber 2. While being guided downstream, part of the horizontal air stream is directed to the cladding burner 6 and the core burner 7, thereby cooling the cladding burner 6 and the core burner 7. Also, after flowing into the cladding forming site A and the core forming site B, part of the air has its direction horizontally guided by the third baffle 23 and the fourth baffle 24 disposed at the other side or downstream side of the reaction chamber 2, and discharged out of the apparatus via the outflow section 35.

Upon supply of the air into the reaction chamber 2, the core burner 7 and the cladding burner 6 are ignited at respective predetermined timings, and flames 31, 30 each containing glass particles are supplied toward the core forming site B and the cladding forming site A, respectively. As the seed rod is drawn upward while adhering and depositing the glass particles on the seed rod, a preform 10 of a desired diameter is formed.

While the flames 30, 31 are supplied through the cladding burner 6 and the core burner 7 toward the cladding forming site A and the core forming site B, the horizontal air streams in the reaction chamber 2 are subjected to thermal expansion due to heat of the flames 30, 31 in passing through the cladding forming site A and the core forming site B, and as a result, is likely to ascend. In this embodiment, however, a three-step baffle comprised of the first baffle 19, the second baffle 21, and the fifth baffle 53 is provided at the upstream side in the air flowing direction relative to a preform forming site, while a two-step baffle comprised of the third baffle 23 and the fourth baffle 24 is provided at the downstream side in the air flowing direction relative to the preform forming site. With this arrangement, ascending of the air streams is suppressed by the first to fifth baffles 19, 21, 23, 24, 53. Furthermore, the cutaways 19a, 21a, 23a, 24a, 53a are formed in the first to fifth baffles 19, 21, 23, 24, 53 each having such a contour as to conform to the diameter of the preform 10. With this arrangement, since the clearance between the respective baffles and the preform 10 is minimized, ascending of the air throughout the reaction chamber 2 is furthermore effectively suppressed.

In this way, excessive fluctuation of air streams is prevented by suppressing ascending of the air by the first to fifth baffles 19, 21, 23, 24, 53, and the cutaways 19a, 21a, 23a, 24a, 53a. Further, since the blocking plate 54 prevents reflux air stream from the outflow section 52 toward the reaction chamber 2, abrupt flame-up and fluctuation of the flames 30, 31 from the cladding burner 6 and the core burner 7 due to such reflux air stream (ascending air stream) can be suppressed. As a result, a cladding 12 and a core 11 of densely and uniformly distributed glass particles are formed. The other operation of the second embodiment is identical to that of the first embodiment.

The first to fifth baffles 19, 21, 23, 24, 53 may be tilted with respect to the air flowing direction within a permissible range, as far as these baffles can effectively suppress ascending of the air flowing-in the reaction chamber 2.

Further, it should be appreciated that the operations and effects of the aforementioned embodiments are merely examples of the present invention, and do not limit the scope of the present invention.

To summarize the present invention, an aspect of the present invention is directed to an apparatus for producing an optical fiber preform in which a preform in a double-cylinder structure consisting of a core and a cladding is formed by depositing glass particles. The apparatus comprises a reactor vessel including a reaction chamber in which the preform is formed, the reaction chamber being so constructed as to direct a gas from one side of the reaction chamber to the other side of the reaction chamber in a horizontal direction; a core burner for forming the core by producing a flame containing glass particles from the one side of the reaction chamber toward a core forming site; a cladding burner for forming the cladding around the core by producing flame containing glass particles from the one side of the reaction chamber toward a cladding forming site; a lifting mechanism for lifting the preform upward while rotating the preform about an axis thereof in such a manner that a tip of the preform and a body of the preform are located in the core forming site and the cladding forming site, respectively; and a baffle arranged above the cladding burner in the reaction chamber for suppressing ascending of the gas in the reaction chamber.

In the above arrangement, since the baffle disposed above the cladding burner suppresses ascending of the air in the reaction chamber, abrupt flame-up and fluctuation of flames through the burners due to ascending of the air are suppressed. As a result, the preform can be produced with high productivity while securing production of the preform of a desired diameter. Further, since the amount of glass particles adhering on the upper wall of the reaction chamber can be reduced owning to suppression of the ascending air, it is less likely that glass particles may come off from the upper wall and adhere to the preform as impurities. Furthermore, the useful life of the cladding burner can be extended by supplying the gas at least onto the cladding burner of a high calorific, value to cool the cladding burner.

The gas to be supplied into the reaction chamber in the prevent invention is preferably a gas which has passed through a filter or a grating. It is desirable to use a HEPA filter as such a filter.

Preferably, the baffle may be arranged in a horizontal direction. With such an arrangement, horizontal stream of the gas is more effectively secured at least one of the upstream side and the downstream side in the gas flowing direction relative to a preform forming site where the preform is to be formed. As a result, abrupt flame-up and fluctuation of the flame can be more effectively suppressed.

Another aspect of the present invention is directed to an apparatus for producing an optical fiber preform in which a preform in a double-cylinder structure consisting of a core and a cladding is formed by depositing glass particles on a seed rod. The apparatus comprises: a reactor vessel including a reaction chamber in which the preform is formed, the reaction chamber being so constructed as to direct a gas from one side of the reaction chamber to the other side of the reaction chamber in a horizontal direction; a core burner for forming the core by producing flame containing glass particles from an upstream side in the gas flowing direction toward a core forming site; a cladding burner for forming the cladding around the core by producing flame containing glass particles from the upstream side toward a cladding forming site; a lifting mechanism for lifting the preform upward while rotating the preform about an axis thereof in such a manner that a tip of the preform and a body of the preform are located in the core forming site and the cladding forming site, respectively; and a gas supplying mechanism for supplying the gas in a zone near an upper wall of the reaction chamber at a speed higher than a speed of flowing the gas in parts other than the zone near the upper wall.

In the above arrangement, since the gas in the zone near the upper wall of the reaction chamber is supplied at a high speed by the gas supplying mechanism, part of the glass particles contained in the flames through the core burner and the cladding burner is blown off downstream along with the high-speed gas stream without adhering to the upper wall of the reaction chamber. Thus, since the amount of glass particles that may adhere to the upper wall of the reaction chamber can be reduced, it is less likely that such glass particles may come off from the upper wall and adhere to the preform as impurities.

Still another aspect of the present invention is directed to an apparatus for producing an optical fiber preform in which a preform in a double-cylinder structure consisting of a core and a cladding is formed by depositing glass particles on a seed rod. The apparatus comprises: a reactor vessel including a reaction chamber in which the preform is formed, the reaction chamber being so constructed as to direct a gas from one side of the reaction chamber to the other side of the reaction chamber in a horizontal direction; a core burner for forming the core by producing a flame containing the glass particles from an upstream side in the gas flowing direction toward a core forming site; a cladding burner for forming the cladding around the core by producing a flame containing glass particles from the upstream side in the gas flowing direction toward a cladding forming site; a lifting mechanism for lifting the preform upward while rotating the preform about an axis thereof in such a manner that a tip of the preform and a body of the preform are located in the core forming site and the cladding forming site, respectively; a baffle horizontally extending in the reaction chamber for securing the gas flowing direction in the reaction chamber horizontally; and a gas supplying mechanism for supplying the gas in a zone near an upper wall of the reaction chamber at a speed higher than a speed of supplying the gas in zones other than the zone near the upper wall. The reaction chamber is divided into a cladding forming section in which the cladding burner is housed, and a core forming section in which the core burner is housed.

In the above arrangement, the baffle suppresses ascending of the gas, which may give rise to abrupt flame-up and fluctuation of the flame, on the upstream side relative to a preform forming site where the preform is to be formed. As a result, the preform can be produced with high productivity while securing production of the preform of a desired diameter. Further, since the gas supplying mechanism supplies the gas in the zone near the upper wall of the reaction chamber at a high speed, part of the glass particles contained in the flames through the core burner and the cladding burner, which may not be used to form the preform and ascend, is blown off downstream without adhering to the upper wall of the reaction chamber. With such an arrangement, the amount of glass particles that may adhere to the upper wall of the reaction chamber can be reduced, and eliminated is a drawback that the glass particles may come off from the upper wall and adhere to the preform as impurities.

Furthermore, since the reaction chamber is divided into the cladding forming section and the core forming section, there is no likelihood that reflux gas stream in the cladding forming section is blown back toward the core burner. Thereby, fluctuation of the flame through the core burner due to reflux stream of gas is reduced, and the core is formed with stable burner flame, thereby improving productivity of the preform.

This application is based on Japanese Patent Application No. 2002-308448 filed on Oct. 23, 2002, respectively, the contents of which are hereby incorporated by references.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

What is claimed is:

1. An apparatus for producing an optical fiber preform having a core and a cladding, comprising:
a reaction chamber in which the preform is formed, the reaction chamber having a structure to flow a gas from one side of the reaction chamber to the other side of the reaction chamber in a horizontal direction;
a core burner for producing a flame containing glass particles from the one side of the reaction chamber toward a predetermined core forming site where a core is formed;
a cladding burner for producing a flame containing glass particles from the one side of the reaction chamber toward a predetermined cladding forming site where a cladding is formed around the formed core;
a lifting mechanism for lifting the preform being formed while rotating the preform about,an axis thereof; and
a baffle arranged above the cladding burner in the reaction chamber for suppressing ascending of the gas in the reaction chamber.

2. The apparatus according to claim 1, wherein the baffle extends in the horizontal direction.

3. The apparatus according to claim 1, wherein the baffle is formed with a cutaway having such a contour as to partially enclose the body of the preform.

4. The apparatus according to claim 1, wherein the baffle is arranged on an upstream side in the gas flowing direction relative to the preform being formed.

5. The apparatus according to claim 4, wherein the baffle includes a plurality of baffles vertically spaced apart from each other on the upstream side of the reaction chamber, at least one of the baffles being disposed above the cladding burner, and at least one of the baffles being disposed between the cladding burner and the core burner.

6. The apparatus according to claim 5, wherein each of the baffles is formed with a cutaway having such a contour as to partially enclose the body of the preform.

7. The apparatus according to claim 6, wherein the cutaway of each baffle has such a size as to match with the diameter of the preform at a corresponding height of each baffle.

8. The apparatus according to claim 4, further comprising a deflector for guiding the gas in the reaction chamber from an outer end in a widthwise direction of the reaction chamber radially inwardly toward the preform being formed.

9. The apparatus according to claim 1, wherein the baffle is arranged on a downstream side in the gas flowing direction relative to the preform being formed.

10. The apparatus according to claim 9, wherein the baffle includes a plurality of baffles vertically spaced away from each other on the downstream side of the reaction chamber, at least one of the baffles being disposed above the cladding burner, and at least one of the baffles being disposed between the cladding burner and the core burner.

11. The apparatus according to claim 10, wherein each baffle is formed with a cutaway having such a contour as to partially enclose the body of the preform.

12. The apparatus according to claim 11, wherein the cutaway of each baffle has such a size as to match with the diameter of the preform at a corresponding height of each baffle.

13. The apparatus according to claim 1, further comprising an outflow section arranged on the other side of the reaction chamber, wherein the outflow section is so configured that a cross section of an outflow passage gradually decreases toward an outflow opening.

14. An apparatus for producing an optical fiber preform having a core and a cladding, comprising:
a reaction chamber in which the preform is formed, the reaction chamber having a structure to flow a gas from one side of the reaction chamber to the other side of the reaction chamber in a horizontal direction;
a core burner for producing a flame containing glass particles from an upstream side in the gas flowing direction toward a predetermined core forming site where a core is formed;
a cladding burner for producing a flame containing glass particles from the upstream side toward a predetermined cladding forming site where a cladding is formed around the formed core;
a lifting mechanism for lifting the preform being formed while rotating the preform about an axis thereof; and
a gas supplying mechanism for supplying the gas into a zone near an upper wall of the reaction chamber in such a manner to flow at a speed higher than the gas flowing into a zone other than the zone near the upper wall.

15. The apparatus according to claim 14, further comprising a blocking member arranged at a downstream side in the gas flowing direction relative to the preform for reducing a reflux stream of the gas toward the core burner.

16. The apparatus according to claim 14, wherein the reaction chamber is divided into a cladding forming section in which the cladding burner is housed, and a core forming section in which the core burner is housed.

17. The apparatus according to claim 14, further comprising an outflow section arranged on the other side of the reaction chamber, wherein the outflow section is so configured that a cross section of an outflow passage gradually decreases toward an outflow opening.

18. An apparatus for producing an optical fiber preform having a core and a cladding, comprising:
a reaction chamber in which the preform is formed, the reaction chamber having a structure to flow a gas from one side of the reaction chamber to the other side of the reaction chamber in a horizontal direction;
a core burner for producing a flame containing glass particles from an upstream side in the gas flowing direction toward a core forming site where a core is formed;
a cladding burner for producing a flame containing glass particles from the upstream side in the gas flowing direction toward a cladding forming site where a cladding is formed around the formed core;
a lifting mechanism for lifting the preform being formed while rotating the preform about an axis thereof;
a baffle horizontally extending in the reaction chamber for allowing the gas to flow in the reaction chamber in a horizontal direction; and
a gas supplying mechanism for supplying the gas into a zone near an upper wall of the reaction chamber in such a manner that the gas flows at a speed higher than the gas flowing in a zone other than the zone near the upper wall;
wherein the reaction chamber is divided into a cladding forming section in which the cladding burner is housed, and a core forming section in which the core burner is housed.

19. The apparatus according to claim 18, further comprising an outflow section arranged on the other side of the reaction chamber, wherein the outflow section is so configured that a cross section of an outflow passage gradually decreases toward an outflow opening.
